(19) United States
(12) Patent Application Publication
(10) Pub. No.: US 2015/0031272 A1
(43) Pub. Date: Jan. 29, 2015

(54) MACHINING TOOL AND METHOD FOR ABRADABLE COATING PATTERN

(71) Applicant: General Electric Company, Schenectady, NY (US)

(72) Inventors: Blake Allen Fulton, Simpsonville, SC (US); Patrick Thomas Walsh, Simpsonville, SC (US); Liming Zhang, Greer, SC (US); Graig Lowell Sarratt, Taylors, SC (US); Douglas John Dix, Greenville, SC (US)

(73) Assignee: General Electric Company

(21) Appl. No.: 13/948,257

(22) Filed: Jul. 23, 2013

(51) Int. Cl. B24B 19/02; B24B 19/22; B23P 13/02; B23C 3/28

(52) U.S. Cl. CPC B24B 19/02; B23C 3/28; B24B 19/22; B23P 13/02; B23C 2210/03; B23C 2215/00; B23C 2220/36
USPC 451/28; 29/557; 29/889.2; 409/131; 409/132; 451/541; 451/178

(57) ABSTRACT

A method for forming a pattern in an abradable coating includes the step of machining a groove in the abradable coating with a machining tool. The machining tool is configured to machine a top surface, a side surface and a bottom surface of the groove simultaneously. A repeating step repeats the machining step until a desired number of grooves is obtained in the abradable coating.

### BACKGROUND OF THE INVENTION

The present invention relates to patterns placed at the surface of components of gas turbine engines, radial inflow compressors and radial turbines, including micro-turbines and turbo-chargers, that are exposed to high temperature environments and, in particular, to a machining tool and method for creating a pattern in abradable coatings.

Gas turbine engines are used in a wide variety of different applications, most notably electrical power generation. Such engines typically include a turbocompressor that compresses air to a high pressure by means of a multi-stage axial flow compressor. The compressed air passes through a combustor, which accepts air and fuel from a fuel supply and provides continuous combustion, thus raising the temperature and pressure of the working gases to a high level. The combustor delivers the high temperature gases to the turbine, which in turn extracts work from the high-pressure gas working fluid as it expands from the high pressure developed by the compressor down to atmospheric pressure.

As the gases leave the combustor, the temperature can easily exceed the acceptable temperature limitations for the materials used in construction of the nozzles and buckets in the turbine. Although the hot gases cool as they expand, the temperature of the exhaust gases normally remains well above ambient. Thus, extensive cooling of the early stages of the turbine is essential to ensure that the components have adequate life. The high temperature in early stages of the turbine creates a variety of problems relating to the integrity, metallurgy and life expectancy of components coming in contact with the hot gas, such as the rotating buckets and turbine shroud. Although high combustion temperatures normally are desirable for a more efficient engine, the high gas temperatures may require that air be taken away from the compressor to cool the turbine parts, which tends to reduce overall engine efficiency.

In order to achieve maximum engine efficiency (and corresponding maximum electrical power generation), it is important that the buckets rotate within the turbine casing or “shroud” with minimal interference and with the highest possible efficiency. During operation, the turbine casing (shroud) remains fixed relative to the rotating buckets. Typically, the highest efficiencies can be achieved by maintaining a minimum threshold clearance between the shroud and the bucket tips to thereby prevent unwanted “leakage” of a hot gas over the tips of the buckets. Increased clearances will lead to leakage problems and cause significant decreases in overall efficiency of the gas turbine engine. Only a minimum amount of “leakage” of the hot gases at the outer periphery of the buckets, i.e., the small annular space between the bucket tips and turbine shroud, can be tolerated without sacrificing engine efficiency. Further, there are losses caused by the flow of hot gas over a particular portion of an interior surface of the turbine shroud when the bucket is not near the particular portion.

The need to maintain adequate clearance without significant loss of efficiency is made more difficult by the fact that as the turbine rotates, centrifugal forces acting on the turbine components can cause the buckets to expand in an outward direction toward the shroud, particularly when influenced by the high operating temperatures. Additionally, the clearance between a bucket tip and the shroud may be non-uniform over the entire circumference of the shroud. Non-uniformity is caused by a number of factors including machining tolerances, stack up tolerances, and non-uniform expansion due to varying thermal mass and thermal response. Thus, it is important to establish the lowest effective running clearances between the shroud and bucket tips at the maximum anticipated operating temperatures.

A significant loss of gas turbine efficiency results from wear of the bucket tips if, for example, the shroud is distorted or the bucket tips rub against the ceramic or metallic flow surface of the shroud. If bucket tips rub against a particular location of the shroud such that the bucket tip is eroded, the erosion of the bucket tip increases clearances between bucket tip and shroud in other locations. Again, any such deterioration of the buckets at the interface with the shroud when the turbine rotates will eventually cause significant reductions in overall engine performance and efficiency.

In the past, abradable type coatings have been applied to the turbine shroud to help establish a minimum, i.e., optimum, running clearance between the shroud and bucket tips under steady-state temperature conditions. In particular, coatings have been applied to the surface of the shroud facing the buckets using a material that can be readily abraded by the tips of the buckets as they turn inside the shroud at high speed with little or no damage to the bucket tips. Initially, a clearance exists between the bucket tips and the coating when the gas turbine is stopped and the components are at ambient temperature. Later, during normal operation the clearance decreases due to the centrifugal forces and temperature changes in rotating and stationary components inevitably resulting in at least some radial extension of the bucket tips, causing them to contact the coating on the shroud and wear away a part of the coating to establish the minimum running clearance. Without abradable coatings, the cold clearances between the bucket tips and shroud must be large enough to prevent contact between the rotating bucket tips and the shroud during later high temperature operation. With abradable coatings, on the other hand, the cold clearances can be reduced with the assurance that if contact occurs, the sacrificial part is the abradable coating instead of the bucket tip.

Abradable coatings may also be designed to have specific patterns to enhance the sealing properties. For example, an abradable coating may have a grooved pattern of parallel curved ridges separated by valleys. The arcuate valleys increase the distance the leakage flow of hot gas must travel, and increase the efficiency of the gas turbine. However, it is a complex process to machine these patterns and many steps are normally required. As stated previously, clearance tolerances are extremely important so the abradable pattern must have a specific height or thickness. In the past, the plateau or top of the pattern's ridges were ground on a first machine prior to machining the grooved pattern. A second machine was used to machine the grooves, and the use of two separate machines made it difficult to obtain specific and uniform valley to ridge heights. Furthermore, the multiple machines require extensive time for setup and operation, high cost and increases cycle time for manufacturing or repair.

### BRIEF DESCRIPTION OF THE INVENTION

In an aspect of the present invention, a method for forming a pattern in an abradable coating includes the step of machining a groove in the abradable coating with a machining tool. The machining tool is configured to machine a top surface, a side surface and a bottom surface of the groove simultaneously. A repeating step repeats the machining step until a desired number of grooves is obtained in the abradable coating.

In another aspect of the present invention, a machining tool configured for forming a pattern in an abradable coating is provided. The abradable coating forms part of a turbomachine component. The machining tool includes a shank and an abrasive head connected to the shank. The abrasive head includes a top grinding surface, a side grinding surface and a bottom grinding surface. The top grinding surface and bottom grinding surface are generally parallel to each other, and the side grinding surface is chamfered and joins both the top grinding surface and the bottom grinding surface.

In yet another aspect of the present invention, a system is provided for creating a pattern in an abradable coating. The abradable coating forms part of a turbomachine component. The system includes a machining tool having a shank and an abrasive head connected to the shank. The abrasive head includes a top grinding surface, a side grinding surface and a bottom grinding surface. The top grinding surface and bottom grinding surface are generally parallel to each other, and the side grinding surface is chamfered and joins both the top grinding surface and the bottom grinding surface. A three-axis rotary mill is configured to move the machining tool in three dimensions and rotate the machining tool at about 1,000 to about 30,000 revolutions per minute (rpm). The system is configured for machining a groove in the abradable coating with the machining tool, and the machining tool is configured to machine a top surface, a side surface and a bottom surface of the groove simultaneously.

### BRIEF DESCRIPTION OF THE DRAWINGS

FIG. 1 illustrates a partial cross-sectional view of a turbomachine component, according to an aspect of the present invention;

FIG. 2 illustrates a schematic view of a pattern for the abradable coating, according to an aspect of the present invention;

FIG. 3 illustrates a side view of a machining tool that is configured for forming the pattern in the abradable coating, according to an aspect of the present invention;

FIG. 4 illustrates a schematic view of a system for creating the pattern in the abradable coating, according to an aspect of the present invention;

FIG. 5 illustrates a flowchart of a method for forming a pattern in an abradable coating, according to an aspect of the present invention; and

FIG. 6 illustrates a schematic view of a system for creating the pattern in the abradable coating using multiple ganged machining tools, according to an aspect of the present invention.

### DETAILED DESCRIPTION OF THE INVENTION

One or more specific aspects/embodiments of the present invention will be described below. In an effort to provide a concise description of these aspects/embodiments, all features of an actual implementation may not be described in the specification. It should be appreciated that in the development of any such actual implementation, as in any engineering or design project, numerous implementation-specific decisions must be made to achieve the developers' specific goals, such as compliance with machine-related, system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “one aspect” or “an embodiment” or “an aspect” of the present invention are not intended to be interpreted as excluding the existence of additional embodiments or aspects that also incorporate the recited features.

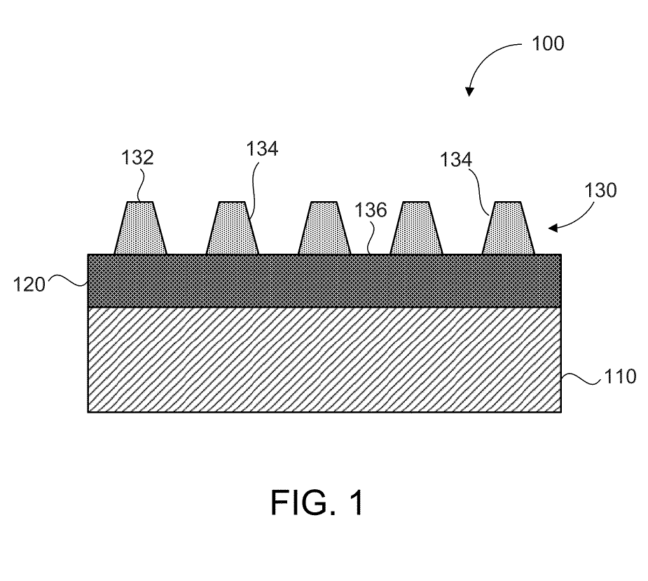

FIG. 1 illustrates a partial cross-sectional view of a turbomachine component 100. The turbomachine component 100 may be a turbine shroud for a gas turbine, or any other turbomachine component having an abradable coating. A substrate 110 is formed of a metallic material or any other suitable material for use in turbomachine components. A bonding layer 120 may be a dense vertically cracked (DVC) thermal barrier coating made of a nickel chromium alloy (e.g., NiCrAlY) or any other suitable metal or metal alloy. An abradable coating 130 is formed into a pattern containing a plurality of ridges and grooves. Each groove is defined by a top surface 132 (or plateau), a side surface 134 and a bottom surface 136 (or valley). The abradable coating 130 may be formed of a ceramic material, such as but not limited to, yttria stabilized zirconia (YSZ), barium strontium aluminosilicate (BSAS) or any other suitable thermal barrier or abradable coating. The side surfaces 134 form chamfered surfaces that join the adjacent top surface 132 (or ridge) and bottom surface 136 (or valley). As can be seen, the top (ridge) 132 and bottom (valley) 136 surfaces are generally flat and parallel to each other, but it may be desirable to have each surface formed to be concave or convex in some applications.

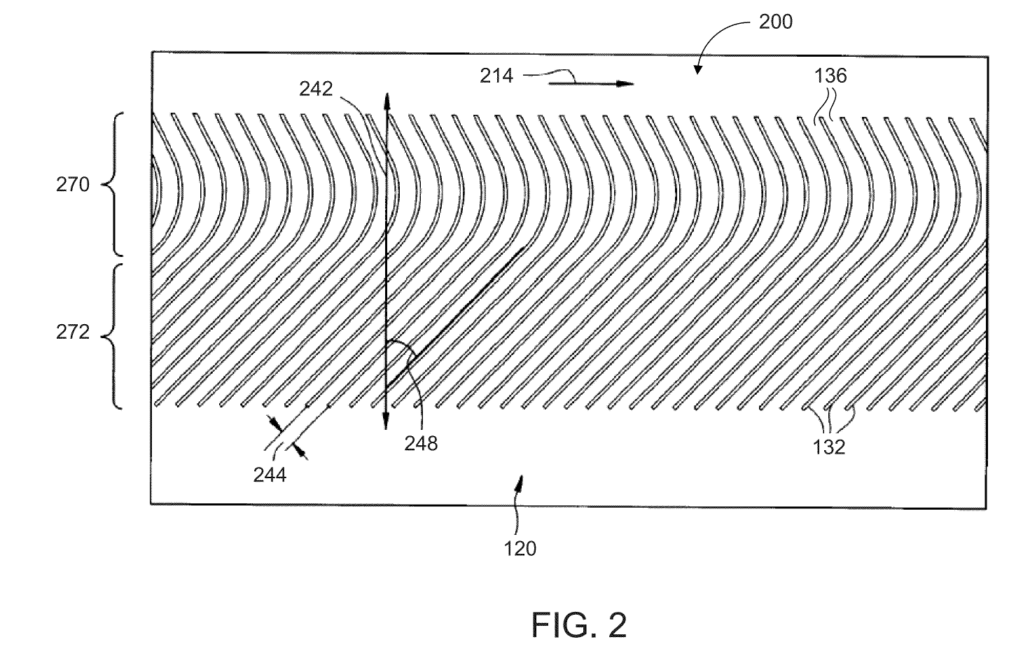

FIG. 2 illustrates a schematic view of a pattern 200 for the abradable coating 130 defining a plurality of ridges (or plateaus) 132 and valleys 136. The pattern includes a curved section 270 and a straight section 272. The curved section 270 is disposed at a portion of the pattern corresponding to the front portion of a turbomachine component (e.g., a turbine bucket tip) when the turbine bucket tip is in abradable communication with the pattern. The straight section 272 is disposed at a portion of the ridges 132 corresponding to the back portion of the turbine bucket tip when the turbine bucket tip is in abradable communication with the pattern. The straight section 272 is at a first end of the ridges 132. The plurality of ridges 132 are disposed on the bonding layer 120 such that each ridge 132 is substantially parallel to each other ridge 132 in the straight section 272. Each ridge 132 is also disposed such that there is an equal distance between contiguous ridges 132, separated by valleys 136 in both the curved and the straight sections 270 and 272. A distance 244 between each ridge 132 may range between about 3.6 mm to about 7.1 mm. The plurality of ridges 216 is disposed in the straight section 272 such that first angle 248 is formed with respect to the reference line 242. First angle 248 ranges from about 20 degrees to about 70 degrees. In an exemplary embodiment, first angle 248 is selected to match an exit angle of a turbine bucket. The curved section 270 includes a radius configured to substantially match a mean camber line shape of the turbine bucket through the curved section 270.

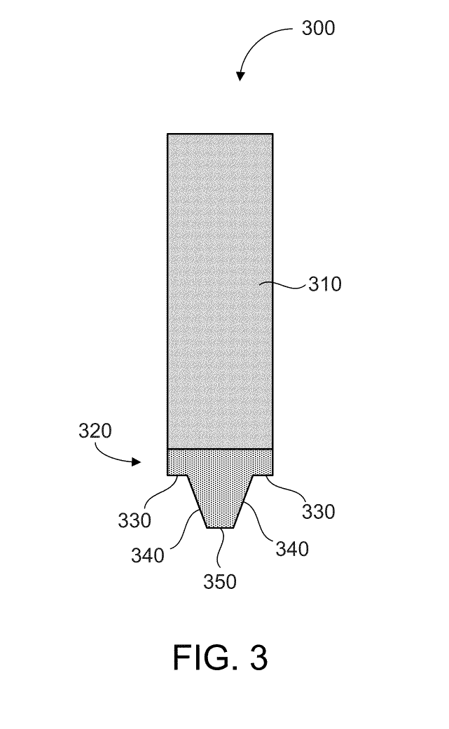

FIG. 3 illustrates a side view of a machining tool 300 that is configured for forming the pattern 200 in the abradable coating 130. The machining tool 300 includes a generally cylindrical shank 310 connected to an abrasive head 320. The abrasive head 320 includes a top (or ridge) grinding surface 330, a side grinding surface 340 and a bottom (or valley) grinding surface 350. The top grinding surface 330 is annularly shaped and extends around the upper portion of the side grinding surface 340. The top grinding surface 330 is used for grinding the ridges 132, as well as setting the ridge height. The bottom grinding surface 350 is circular shaped and is used for grinding the valleys 136, as well as setting the depth of the valleys in relation to the ridge height. The top grinding surface 330 and bottom grinding surface 350 are generally parallel to each other, but these surfaces could also be non-flat, curved, concave, convex or shaped in any desired form as desired in the specific application. The side grinding surface 340 is frusto-conically shaped on its outer surface and is adjacent to both the top grinding surface 330 and bottom grinding surface 350. It will be appreciated that the side grinding surface forms the chamfered surface of the valley walls 134.

The abrasive head may be formed of, or coated with, diamond, diamond plated, cubic boron nitride (CBN), ceramic or silicon carbide. These abrasive materials (and abrasive head 320) will grind through the abradable coating 130 as the machining tool is rotated at sufficient speeds to form pattern 200. One advantage of the present invention is that the ridges 132, valley walls 134 and valley bottoms 136 are ground simultaneously. This enables a separate ridge grinding step to be omitted (or not performed) and speeds up the pattern making process as well as increases pattern quality by providing excellent control over ridge height, valley width and valley depth of the final pattern.

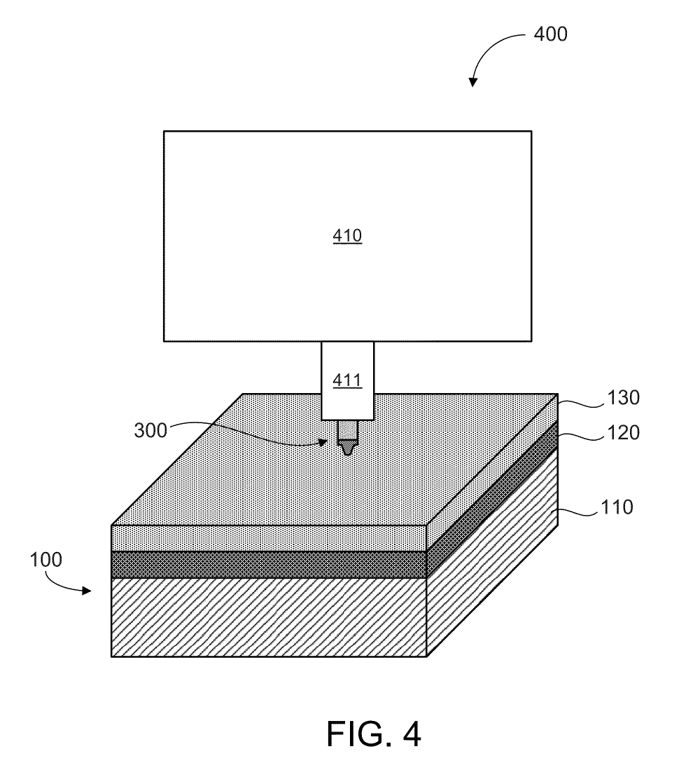

FIG. 4 illustrates a schematic view of a system 400 for creating a pattern 200 in an abradable coating 130. As stated previously, this pattern could be used in a turbomachine component such as a turbine shroud in a gas turbine. The machining tool 300 is mounted in a three-axis rotary mill 410 that is configured to move the machining tool 300 in three dimensions, as well as rotate the machining tool 300 at about 1,000 to about 30,000 revolutions per minute (rpm). The mill 410 could also rotate the tool 300 at speeds above or below this range as well, as desired in the specific application. As shown, the machining tool may be mounted in a chuck 411 of mill 410. The chuck 411 and associated motor may be mounted on a robotic arm (not shown), or the turbomachine component 100 may be mounted on a table capable of three dimensional movement.

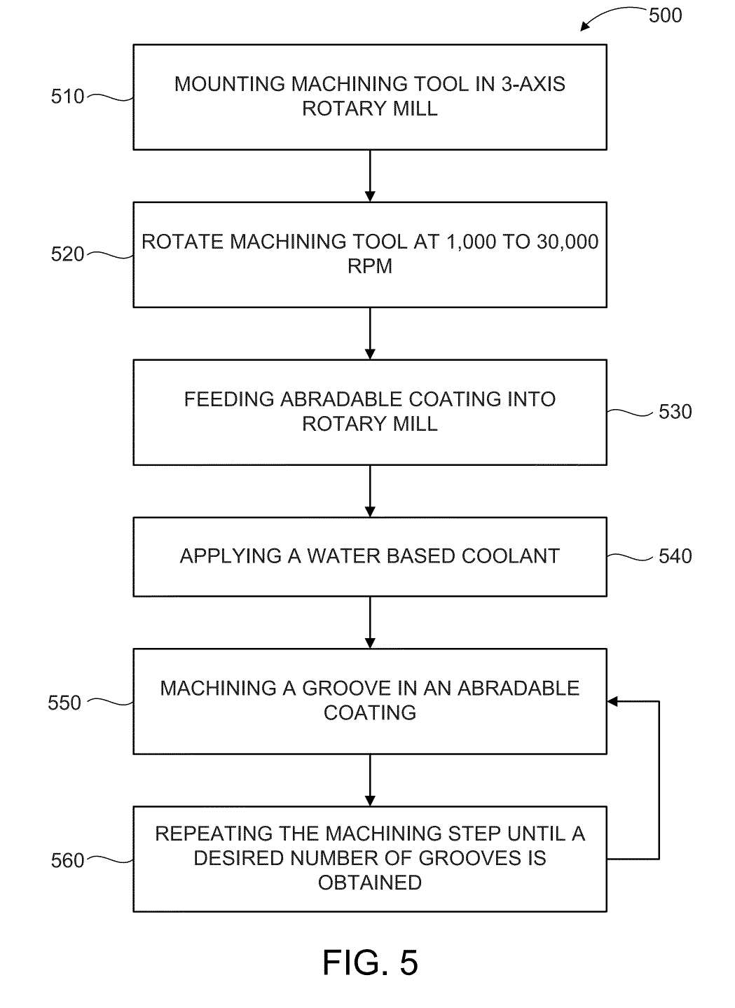

FIG. 5 illustrates a flowchart of a method 500 for forming a pattern 200 in an abradable coating 130. The method may include the steps 510 of mounting the machining tool 300 in a three-axis rotary mill 410. Step 520 may include rotating the machining tool 300 at about 1,000 to about 30,000 rpm and specifically during a subsequent machining step. Step 530 includes feeding the abradable coating 130 (or turbomachine component 100) into the rotary mill 410 at about 1 to about 100 inches per minute. Step 540 includes applying a water based flood coolant to the machining tool 300 and abradable coating 130 during the machining step. Step 550 includes machining a groove in the abradable coating 130. In this step, the ridge 132 (or top), sidewall 134 and valley 134 (or bottom) are all formed (i.e., machined) simultaneously. Step 560 repeats the machining step 550 until a desired number of grooves is obtained or the pattern is finished. Step 550 may also include forming multiple grooves simultaneously by the use of multiple machining tools 300 ganged together.

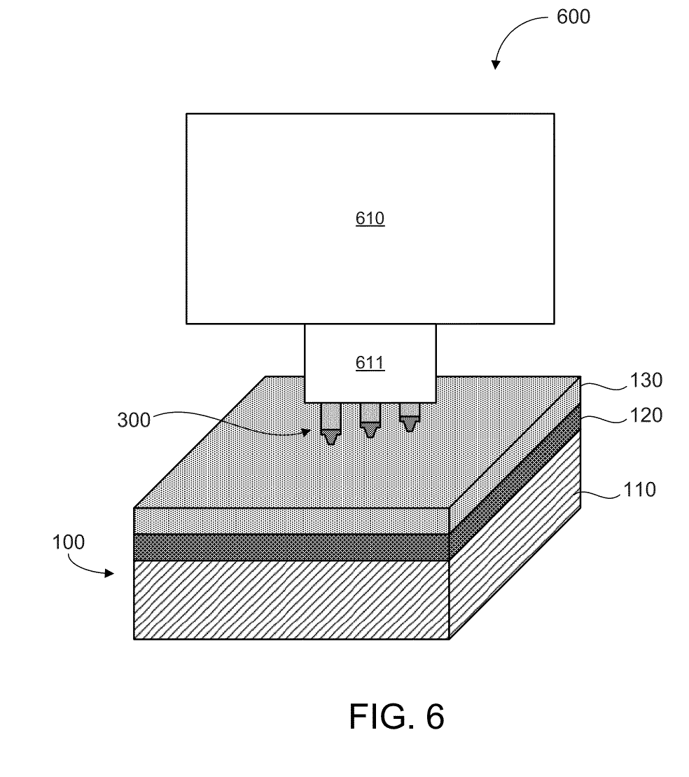

FIG. 6 illustrates a schematic view of a system 600 for creating a pattern 200 in an abradable coating 130. As stated previously, this pattern could be used in a turbomachine component such as a turbine shroud in a gas turbine. Multiple machining tools 300 are ganged together and mounted in a three-axis rotary mill 610 that is configured to move the machining tools 300 in three dimensions, as well as rotate the machining tools 300 at about 1,000 to about 30,000 revolutions per minute (rpm). As shown, the machining tool may be mounted in a multi-chuck 611 of mill 610. The chuck 611 and associated motor(s) may be mounted on a robotic arm (not shown), or the turbomachine component 100 may be mounted on a table capable of three dimensional movement.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for forming a pattern in an abradable coating, the method comprising the steps of:
machining a groove in the abradable coating with a machining tool, the machining tool configured to machine a top surface, a side surface and a bottom surface of the groove simultaneously; and
repeating the machining step until a desired number of grooves is obtained in the abradable coating.

2. The method of claim 1, wherein a separate grinding step of grinding only the top surface is not performed.

3. The method of claim 1, wherein the abradable coating is part of a turbomachine component.

4. The method of claim 3, wherein the abradable coating is comprised of a ceramic material and the turbomachine is a gas turbine.

5. The method of claim 1, wherein the machining tool is mounted in a three-axis rotary mill and the machining tool is rotated at about 1,000 to about 30,000 revolutions per minute (rpm) during the machining step.

6. The method of claim 5, further comprising:
feeding the abradable coating into the rotary mill at about 1 to about 100 inches per minute.

7. The method of claim 5, further comprising:
applying a water based coolant to the machining tool and abradable coating during the machining step.

8. The method of claim 7, wherein the machining tool contains an abrasive surface comprising at least one of:
diamond, cubic boron nitride (CBN), ceramic or silicon carbide.

9. The method of claim 5, wherein multiple machining tools are ganged together to form multiple grooves simultaneously.

10. The method of claim 1, wherein the top surface and bottom surface are generally parallel to each other, and the side surface forms a chamfered surface joining the top surface and bottom surface.

11. A machining tool configured for forming a pattern in an abradable coating, the abradable coating forming part of a turbomachine component, the machining tool comprising:
a shank;
an abrasive head connected to the shank, the abrasive head comprising a top grinding surface, a side grinding surface and a bottom grinding surface;
wherein the top grinding surface and bottom grinding surface are generally parallel to each other, and the side grinding surface is chamfered and joins both the top grinding surface and the bottom grinding surface.

12. The machining tool of claim 11, wherein the abrasive head comprises at least one of:
diamond, cubic boron nitride (CBN), ceramic or silicon carbide.

13. The machining tool of claim 12, wherein the abradable coating is comprised of a ceramic material and the turbomachine is a gas turbine.

14. The machining tool of claim 12, wherein the turbomachine component is a gas turbine shroud.

15. The machining tool of claim 11, wherein the machining tool is mounted in a three-axis rotary mill configured to rotate the machining tool at about 1,000 to about 30,000 revolutions per minute (rpm).

16. A system for creating a pattern in an abradable coating, the abradable coating forming part of a turbomachine component, the system comprising:
a machining tool having a shank and an abrasive head connected to the shank, the abrasive head comprising a top grinding surface, a side grinding surface and a bottom grinding surface, wherein the top grinding surface and bottom grinding surface are generally parallel to each other, and the side grinding surface is chamfered and joins both the top grinding surface and the bottom grinding surface;
a three-axis rotary mill configured to move the machining tool in three dimensions and rotate the machining tool at about 1,000 to about 30,000 revolutions per minute (rpm); and
wherein the system is configured for machining a groove in the abradable coating with the machining tool, and the machining tool is configured to machine a top surface, a side surface and a bottom surface of the groove simultaneously.

17. The system of claim 16, wherein the abrasive head comprises at least one of:
diamond, cubic boron nitride (CBN), ceramic or silicon carbide.

18. The system of claim 17, wherein the abradable coating is comprised of a ceramic material and the turbomachine is a gas turbine.

19. The system of claim 18, wherein the turbomachine component is a gas turbine shroud.
